(19) United States
(12) Patent Application Publication
(10) Pub. No.: US 2015/0074118 A1
(43) Pub. Date: Mar. 12, 2015

(54) SYSTEMS, METHODS AND COMPUTER-READABLE MEDIA FOR MANAGING AND INCENTIVIZING DATA ENTRY

(71) Applicant: Bellefield, LLC, Pittsburgh, PA (US)

(72) Inventors: Daniel Garcia-Sanchez, Wexford, PA (US); Gabriela Isturiz, Pittsburgh, PA (US); John Charles Kuntz, Pittsburgh, PA (US)

(73) Assignee: Bellefield, LLC, Pittsburgh, PA (US)

(21) Appl. No.: 14/021,819

(22) Filed: Sep. 9, 2013

(51) Int. Cl. G06F 17/30

(52) U.S. Cl. CPC G06F 17/3053
USPC 707/748

(57) ABSTRACT

Systems, methods and computer-readable storage media for managing and incentivizing data entry are described. A data management system may include a plurality of user profiles associated with system users capable of entering data entry records into the data management system. The data entry records may be scored to indicate a correlation between the data entry record and at least one data entry goal, such as timeliness, completeness and/or accuracy. The scores may be used to encourage, motivate or otherwise incentivize system users to enter data entry records that conform to the goals of the data management system. The scores may be ranked and made accessible by system users, for example, so that each user may be compared among his peers. In addition, the scores may be used as part of a reward/penalty system administered, for example, by an operator of the data management system.

### BACKGROUND

Technological advances in the workplace have made most required tasks easier and more efficient. Nonetheless, certain basic responsibilities still remain a challenge for employers. One challenge is timely and accurate data entry, particular for professional organizations that require time entry records, such as the records required by most law firms. Despite the availability of advanced time-entry software applications developed to make time entry easier for attorneys, most law firms still struggle to obtain timely and accurate time records. This situation can lead to inaccurate client bills and lost revenue. As such, the barriers to productive data entry appear to include multiple factors beyond ease of entering records, such as remote access and psychological factors. Accordingly, it would be beneficial to provide a data entry solution capable of efficiently and effectively addressing the multiple factors that prevent timely and accurate data entry.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In an embodiment, a system configured to manage and incentivize data entry may comprise a processor and a non-transitory, computer-readable storage medium in operable communication with the processor. The computer-readable storage medium may contain one or more programming instructions that, when executed, cause the processor to receive a data entry record associated with at least one of a plurality of user profiles and to generate data entry information associated with the data entry record. The computer-readable storage medium may contain one or more programming instructions that, when executed, cause the processor to determine at least one data entry score associated with at least one of a plurality of user profiles based on the data entry information responsive to receiving the data entry element. The data entry score may be configured to indicate a correlation between the data entry information and at least one data entry goal.

In an embodiment, a computer-implemented method for managing and incentivizing data entry may comprise, by a processor, receiving a data entry record associated with at least one of a plurality of user profiles and generating data entry information associated with the data entry record. The computer-implemented method may comprise, by a processor, determining at least one data entry score associated with at least one of a plurality of user profiles based on the data entry information responsive to receiving the data entry element. The data entry score may be configured to indicate a correlation between the data entry information and at least one data entry goal.

In an embodiment, a computer-readable storage medium may include computer-readable program code configured to manage and incentivize data entry embodied therewith. The computer-readable program code may comprise computer-readable program code configured to receive a data entry record associated with at least one of a plurality of user profiles and to generate data entry information associated with the data entry record. The computer-readable program code may further be configured to determine at least one data entry score associated with at least one of a plurality of user profiles based on the data entry information responsive to receiving the data entry element, the data entry score being configured to indicate a correlation between the data entry information and at least one data entry goal.

### BRIEF DESCRIPTION OF THE DRAWINGS

The above and other objects of the present invention will become more readily apparent from the following detailed description taken in connection with the accompanying drawings.

FIG. 1 depicts an illustrative data entry management system according to some embodiments.

FIG. 2 depicts an illustrative client data entry interface and data entry information according to an embodiment.

FIG. 3 depicts an illustrative data entry management system according to an embodiment.

FIG. 4 depicts a flow diagram for an illustrative method for managing and incentivizing data entry using a data management system configured according to some embodiments.

FIG. 5 illustrates various embodiments of a computing device for implementing the various methods and processes described herein.

### DETAILED DESCRIPTION

The described technology is directed to systems, methods and computer-readable media for managing and incentivizing the performance of data entry. For example, a data entry management system (the “system”) may include user profiles associated with users who may use the system to perform data entry operations, such as entering information involving work performed, sales completed, tasks completed, or the like. Each user profile may be associated with a data entry score configured to indicate how the data entry records of the user correlate with one or more data entry goals of the system operator. For instance, data entry goals may include, without limitation, timeliness of data entry, accuracy of information in the data entry record, completeness of the data entry record, or combinations thereof. In an embodiment, data entry information may be generated each time that a data entry record is created. The data entry information may be configured to provide data about the data entry record and the entry thereof into the system, including data that may be used to calculate a data entry score for the user profile.

According to some embodiments, the data entry scores may be used to encourage, support, facilitate, influence, motivate, or otherwise incentivize system users to enter data entry records in accordance with the data entry goals. For example, the data entry score may be used as part of a reward system or may be available to other system users, for example, within a ranked list of users. Providing a reward and/or a penalty to system users and/or groups of users may incentivize users to provide data entry records in a manner that generates a higher data entry score. Ranking and listing the data entry scores of users may influence system users to enter data entry records in line with data entry goals in an effort to increase their individual data entry score in relation to their peers, for instance, through peer pressure, reward/penalty influences or other motivating factors. In an embodiment, the data entry management system may be used as part of a time entry system for an entity, such as a professional firm, to obtain more timely and/or accurate time entry records from employees.

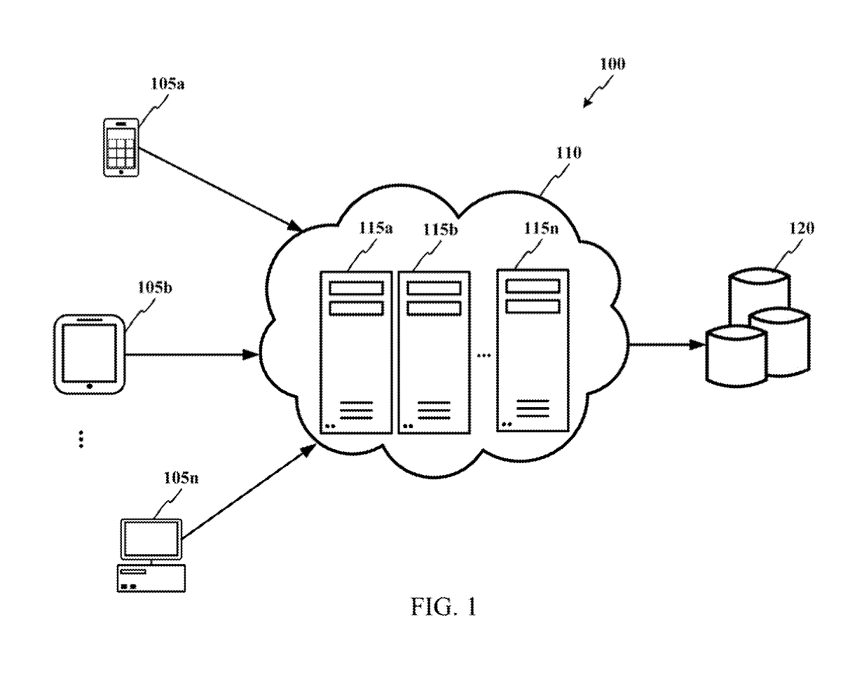

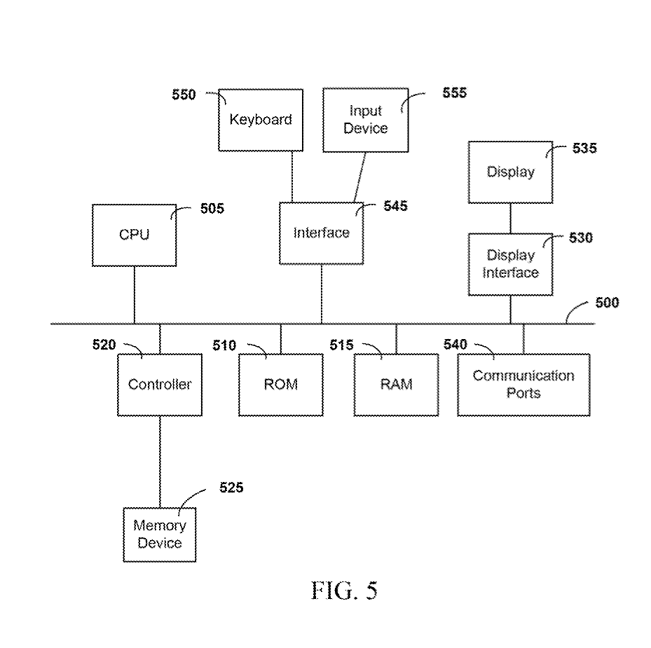

FIG. 1 depicts an illustrative data entry management system according to some embodiments. As shown in FIG. 1, a data entry management system 100 may include one or more server computing devices 115a-115n, which may generally include a processor, a non-transitory memory or other storage device for housing programming instructions, data or information regarding one or more applications, and other hardware, including, for example, the central processing unit (CPU) 505, read only memory (ROM) 510, random access memory (RAM) 515, communication ports 540, controller 520, and/or memory device 525 depicted in FIG. 5 and described below in reference thereto. In an embodiment, the programming instructions may include a data entry management application (the “management application”) configured to manage various functions of the data entry management system 100.

System users may access the data entry management system 100 using various logic devices, including, without limitation, a smartphone 105a, a tablet computing device 105b and a personal computer (PC) 105n. Embodiments are not limited to the logic devices 105a-105n depicted in FIG. 1, as any logic device capable of operating according to some embodiments now in existence or developed in the future is contemplated herein. The logic devices 105a-105n may access the server computing devices 115a-115n and the management application being executed thereon via a network 110 through a wired or wireless data connection, such as an Ethernet connection, a local area network connection (e.g., a company intranet), a wide area network connection (e.g., the Internet), or any other type of data connection known to those having ordinary skill in the art. The logic devices 105a-105n may interface with the management application through various platforms, including, without limitation, a client application, web-based application, over the Internet, and/or a mobile application (for example, a “mobile app” or “app”).

In an embodiment, the management application may be configured to generate user profiles that include information associated with system users such as name, device, company or firm, occupation, security access, user name, password, historical data entry information, data entry score and associated information, and any other information capable of being used by embodiments described herein. For instance, each system user may be required to register with the management application and create a user profile in order to access functions of the data entry management system 100.

The management application may be configured to receive data entry records from the logic devices 105a-105n. The data entry records may be configured according to the operation of the data entry management system 100. Non-limiting examples of data records include time entry records configured to record work performed by system users, sales records configured to record completed sales, customer support records and/or technical support tickets configured to capture support staff calls with customers, or the like. The data entry records may be processed by the management application and, in some embodiments, may be stored in one or more data stores 120.

In an embodiment, each user profile may be associated with a data entry score. The data entry score may be configured to indicate how data entry records entered by a system user conform to one or more goals established for the data entry management system 100. A non-limiting example of a goal is the timeliness of data entry records, for instance, in a time entry system. In such an example, the data entry score for a system user may indicate whether the system user enters time entry records into the data entry management system 100 close in time to the date and/or time that the work was performed.

Another example of a goal is the completeness of data entry records, for example, in a medical insurance claim data entry system. In such an example, the data entry score for a system user may indicate whether the system user enters data entry records having a threshold number of fields completed, all required fields completed, or the like.

In an embodiment, the data entry score may include a numerical score, such as a score based on points awarded to data entry records based on a particular scoring technique. The numerical score may be configured according to various techniques, such as a total score based on summing all of the individual scores for each data entry record, an average score based on the average score for each data entry record, or the like. In addition, the numerical score may be calculated using various statistical methods known to those having skill in the art.

In an embodiment, the data entry score may be converted to one or more symbols configured to indicate the level of the score. A non-limiting example may involve assigning letter grades (for instance, A, B, C, D, and F) to the data entry score based on a grading scheme. In this non-limiting example, each record may be scored on a scale, such as a 0-100 scale, and letter grades may be assigned to certain portions of the scale (for example, A is assigned to 90-100, B is assigned to 75-90, or the like). In another non-limiting example, the data entry scores may be assigned words or phrases, such as “good,” “average,” “fair,” “poor,” “needs improvement,” “satisfactory,” “unsatisfactory,” “high performer,” or the like.

In an embodiment, the management application may be configured to rank the data entry scores and/or the symbol representations of the data entry scores. In this manner, the system users and/or others having access to the data entry scores may view how the system users compare with each other. In some embodiments, the ranked data entry scores may be further segmented into groups. For instance, the top five percent of data entry scores may be formatted into a “wall of pride,” the bottom five percent into a “wall of shame,” or the like. In another embodiment, users may receive rewards or “badges” for achieving predetermined goals, such as receiving an “A” in a letter scoring system, reaching a target score level, or maintaining a certain score level for a threshold amount of time. In the alternative, users may receive penalties and and/or have rewards (for example, badges) taken away responsive to failing to achieve certain predetermined goals.

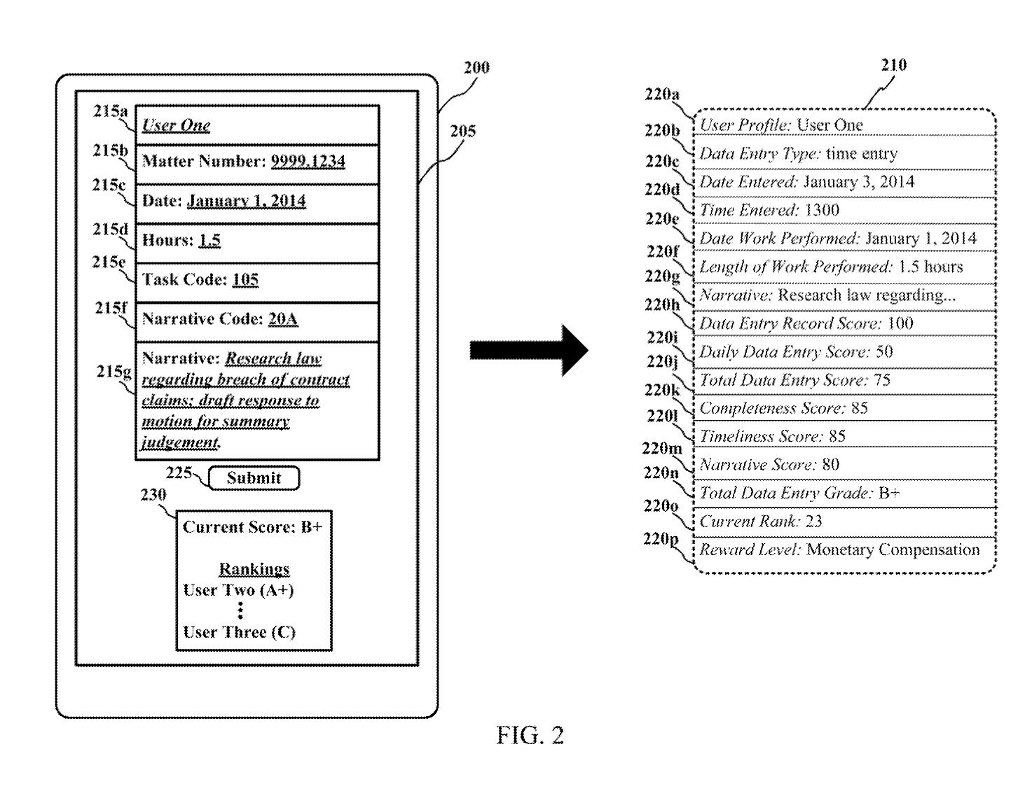

According to some embodiments, the management application may generate data entry information associated with at least some of the data entry records (for example, see FIG. 2). The data entry information may be configured to provide information about the data entry record and/or the receipt thereof by the data management application. For instance, the data entry information may include the system user who entered the data entry record, the date and/or time of receipt of the data entry record, the completeness of the data entry record (for example, information indicating whether the data entry record fields are complete), the accuracy of the data entry record (for example, information indicating whether the data entry record contains mistakes, misinformation, incomplete entries, or the like), or any other type of information capable of being used by the management application configured according to some embodiments described herein.

According to some embodiments, the data entry information may be used to generate a data entry score for a user profile. The management application may process the data entry information associated with a data entry record to generate the data entry score for the user profile associated with the data entry record. For example, the management application may be configured to score each data entry record according to a specified scoring system. The scoring system may include various scoring factors, such as timeliness, completeness, accuracy, combinations thereof, or the like. For instance, a data entry record may be timely yet incomplete. An illustrative scoring system may only score based on timeliness and may generate a high data entry score (for example, 80 out of 100) for the data entry record. Another illustrative scoring system may only score based on completeness and may generate a low data entry score (for example, 40 out of 100) for the data entry record. A further illustrative scoring system may score based on timeliness and completeness and may generate an intermediate data entry score (for example, 60 out of 100) for the data entry record. In this manner, the management application may allow system users to observe how their data entry habits correlate with the data entry goals for users of the data entry management system 100.

In an embodiment, the various factors used in a particular scoring system may be weighted, for example, to prioritize the scoring factors. For instance, in the illustrative scoring system based on timeliness and completeness described above, timeliness may be weighted higher than completeness. As such, this scoring system may generate a data entry score that is between an intermediate data entry score and a high data entry score (for example, 70 out of 100) for the data entry record that is timely but incomplete.

In an embodiment, a user profile may be associated with a “running” or “continuous” data entry score that is updated with each data entry record. Accordingly, each time that the system user enters a data entry record, the management application may process the data entry record, generate data entry information, score the data entry record, and update the data entry score for the user profile. In another embodiment, the data entry score associated with a user profile may be recorded at specified time intervals (for example, daily, weekly, monthly, or the like) or through user action. As such, a user profile may be associated with a running data entry score as well as data entry scores for individual time intervals.

In an embodiment, a user profile may be associated with multiple data entry scores. For example, the data management application may provide more than one score for each data entry record based on various goals of the system operator. An illustrative and non-restrictive example provides that a data entry record may receive a “timeliness” data entry score based on a timeliness scoring system and an “accuracy” data entry score based on an accuracy scoring system. In another example, a system user may record different types of data entry records into the data entry management system 100, such as time data entry records, sales data entry records, and customer support data entry records, each of which may be scored according to a different scoring system. The different data entry scores may be maintained as separate scores, combined into one score or combinations thereof. For instance, the time data entry records may be associated with a time entry data entry score, while the sales and customer support data entry records may be associated with a combined general data entry score.

In an embodiment, the management application may be configured to provide alerts to system users reminding them to perform various data entry tasks. For example, in a timekeeping system, the management application may be configured to send out a reminder at the close of business each weekday (for instance, at 5:00 p.m.) and/or at the start of each weekday (for instance, at 9:00 a.m.) reminding users to enter their time for a particular day.

FIG. 2 depicts an illustrative client data entry interface and data entry information according to an embodiment. As shown in FIG. 2, a client computing device 200 may access the management application through a client platform, such as a client application, web-based application, over the Internet, and/or a mobile app. The client computing device 200 may include any type of logic device capable of operating according to some embodiments described herein, including, without limitation, a PC, a laptop computer, a smartphone, a personal digital assistant (PDA), a tablet computing device, or any other logic and/or computing device now known or developed in the future

The client platform may be configured to present a user interface 205 on a display component of the client computing device 200. A system user may use the user interface 200 to enter data entry records into a data entry management system, such as the data entry management system 100 depicted in FIG. 1. In the non-limiting example embodiment depicted in FIG. 2, the data entry management system may be at least partially configured as a time keeping system, for instance, for attorneys at a law firm. However, this is for illustrative purposes only as the data entry management system 100, management application, and/or user interface 205 may be configured for any type of data entry system capable of operating according to embodiments described herein.

The user interface 205 may include various graphical user interface (GUI) elements configured to present information and/or to allow a user to submit information. For example, the user interface 205 may include time record elements, such as a name element 215a, a matter number element 215b, a work performed data element 215c, a number of hours element 215d, a task code element 215e, a narrative code element 215f, and a narrative element 215g. The time record elements 215a-215g may be used by a system user to input information associated with a time record for work performed. In an embodiment, the data entry record may be received by the management application responsive to the system user selecting a submit element 225 on the user interface 205 or otherwise indicating that the record may be transmitted to the management application.

The data entry scores of the system user associated with the use profile element 220a (for example, the system user logged in to the data entry management application through the client computing device 200) may be able to view their data entry score through a score display element 230. In some embodiments, one or more individuals may have access to the data entry scores of the system users through the score display element 230 and/or other display component (for example, a website). In an embodiment, a system user may have access to the data entry score associated with their user profile, including any information used to generate the data entry score and/or any symbols used to represent the data entry score. The system user may have access to the data entry score and/or information used to generate the data entry score in various forms, such as historical data, current scores, past scores, weekly scores, monthly scores, trending information, information involving how the scores were calculated, the scores of individual records or portions thereof, or combinations thereof.

In another embodiment, a supervisor may have access to the data entry scores of system users under her supervision. In a further embodiment, the data entry scores may be available to all, substantially all, or one or more subsets of the system users. In an embodiment, the system users may be segmented into one or more subsets based on various criteria and allowed to view the data entry scores of specified system users. For instance, the system users may be segmented based on office, department, position, level, business unit, or the like. The subsets are not limited to representing actual divisions within an entity using the data entry management application. According to some embodiments, system users may be divided into any form of group and compete amongst other groups, including, without limitation, leagues, conferences, or other artificial divisions. Similar to the manner in which rewards/penalties may be applied to individual system users according to some embodiments, rewards/penalties may also be applied to groups. In an embodiment, one or more groups may compete, with rewards being given to the top or a set of top groups. In this manner, all or substantially all members of each group may be incentivized to compel other group members, for instance, through providing encouragement, peer pressure, or the like, to achieve data entry score goals.

In a further embodiment, the management application may generate data entry scores for the subsets (a “subset data entry score”) based on the scores of system users associated therewith. For example, an office, department, employee level, or the like may be associated with a subset data entry score for the entire group of users contained therein. The subset data entry score may be determined using various processes. Non-limiting examples include averaging all or a portion of the data entry scores of the subset users, selecting the highest, lowest, median or other data entry score, or combinations thereof. In this manner, different segments within a business entity may “compete” and be compared to each other to motivate or otherwise influence the segments and/or users within the segments to achieve higher data entry scores. For example, offices and/or departments within the same company may be able to view the subset data entry score of other offices and/or departments. In another example, in which the data management system is used in a law firm, partners and associates may be segmented into different subsets and may be motivated, incentivized or otherwise influenced compete for the highest subset data entry score. The subset data entry score may be used in the same manner as the data entry score for individual users according to some embodiments described herein.

In an embodiment, the data entry scores may be accessible by system users through the management application, such as on a website or presented on an application user interface (for instance, a mobile app user interface), including the display element 235 on the user interface 205. The management application may be configured to provide access to the data entry scores by system users or subsets of system users. For instance, all of the system users in a department subset may have access to the data entry scores of other system users in the department subset. In another instance, all or substantially all system users may be able to access the data entry scores of all or substantially all of the other system users. In this manner, the users may be able to compare their data entry score with their peers. This may operate, among other things, to encourage certain users to perform data entry in accordance with the goals of the data entry management system in order to achieve a higher score, for instance, through peer pressure, reward/penalty influences, or other motivating factors.

As shown in FIG. 2, data entry information 210 may be generated based on the data entry record created through the user interface 205. The data entry information 210 may include various information elements 220a-220p associated with one or more data entry records, the user profile, the data entry score, or the like. For example, the data entry information 210 may include information about the actual entry of a data entry record, such as a user profile element 220a storing the user profile associated with the data entry record and a data entry type element 220b configured to indicate the type of data entry record. According to some embodiments, the type of data entry record may determine the categorization and/or scoring system used for the data entry record. The data entry information 210 may also include date/time stamp information, such as a date entered element 220c and a time entered element 220d, and data elements 220e-220g for the actual data entered in a data entry record.

The data entry information 210 may also include scoring elements 220h-220m for the data entry records. Illustrative scoring elements include, without limitation, a data entry record score element 220h for a data entry score associated with an individual data entry record, a daily data entry score element 220i for a daily total score, and a total data entry score element 220j for the total data entry score for the user profile 220a. In an embodiment, each record may be scored according to various scoring systems. For example, the completeness of the data entry record may be scored according to a completeness scoring system and stored in a completeness score element 220k. For instance, in an illustrative and non-restrictive completeness scoring system, each record may be scored for completeness on a scale from 0 (low) to 100 (high), with 100 being a complete record. Points may be assigned to various elements of the data entry record. The data management system may determine the value of the completeness score element 220k by adding the number of points assigned to each complete element of the record. In another example, the timeliness of the data entry record may be scored according to a timeliness scoring system and stored in a timeliness score element 220l. For instance, in an illustrative and non-restrictive completeness scoring system, each record may be scored for timeliness of data entry on a scale from 0 (low) to 100 (high), with 100 being a timely record. The data management system may determine the value of the timeliness score element 220l by subtracting 10 from 100 for each twelve-hour period that passes from the time that the event captured in the time entry record occurred until the record was entered in the data entry management system.

In an embodiment, portions of each record may be scored according to various scoring systems. For instance, the narrative 215g of a data entry record may be scored according to various criteria, such as whether the narrative uses names (for example, client names, party names, or the like, which may indicate a more complete time entry narrative), proper punctuation, or other preferred stylistic attributes (for example, starting each sentence with a verb), or the like. The score calculated for the narrative 220h may be stored in a narrative score element 220m.

The data entry information 210 may include information associated with the data entry score 220i, such as any symbols associated with the data entry score. For example, the management application may be configured to assign letter grades to data entry scores 220i to determine a total data entry grade 220n. In another example, the management application may be configured to rank the data entry score 220i of the user profile 220a against other system users or portions thereof (for instance, only system users at the same employment level, such as associates, paralegals, or the like, and/or department are ranked). In an embodiment, the data entry information 210 may include information associated with rewards and/or penalties related to the data entry score 220i. For instance, the user profile 220a may be associated with a reward level element 220p configured to indicate which type of reward that the user profile is eligible for within the data entry management system, such as monetary compensation.

The data entry information 210 is not limited to the elements 220a-220p depicted in FIG. 2 as the data entry management system may be configured to generate and/or use any type of information capable of operating according to embodiments described herein.

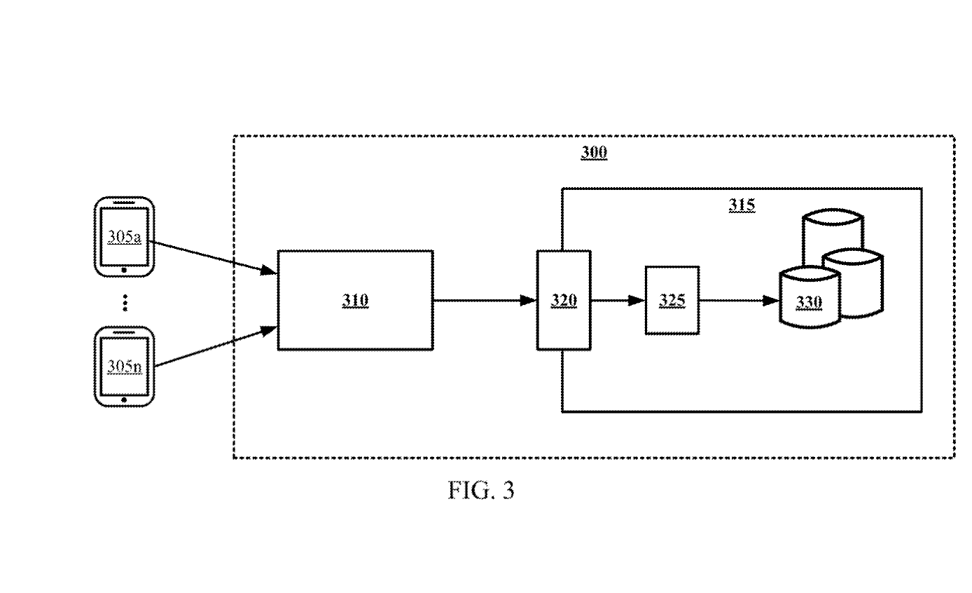

FIG. 3 depicts an illustrative data entry management system according to an embodiment. As shown in FIG. 3, a data entry management system 300 may include an entity network 315 used by an entity, such as a law firm or other organization using the data entry management system, to handle various aspects of their data entry requirements. Access to the entity network 315 may be through a firewall 320, for example, to read and/or write to a database 330 located within the entity network.

A data entry management service 310 (“management service”) may be configured to manage communication between client computing devices 305a-305n and the entity network 315. The management service 310 may be executed on one or more computing devices, such as server computing devices, outside of the entity network 315. In an embodiment, the management service 310 may be resident within a distributed computing environment, such as a cloud computing environment. According to some embodiments, the management service 310 may include various modules and/or applications configured to perform various functions, such as communication functions. For example, the management service 310 may use certain middleware applications (for instance, “application fabric” software) that facilitate communication across various platforms using multiple protocols. An illustrative and non-restrictive example is the Windows® Azure™ AppFabric cloud middleware platform sold by the Microsoft® Corporation of Redmond, Wash.

A system user may generate a system request by, for example, initiating entry of a data entry record or requesting information from a management application interface presented on one of the client computing devices 305a-305n. The request may be transmitted to the management service 310 using various communication protocols, including encrypted communication protocols such as transport layer security (TLS) or secure sockets layer (SSL) communication protocols. The management service 310 may be configured to authenticate the system user, for instance, through a user name and password and to check authorization to access the data entry management system 300, such as through portal settings.

Responsive to authentication and/or authorization of the request, the management service 310 may forward the request to the entity network 315, for instance, through application fabric software. The request may be received by a connection module 325 executing within the entity network 315 behind the firewall 320. In an embodiment, the connection module 325 may include the same or similar middleware application, such as application fabric software, for facilitating communication with the management service 310. The connection module 325 may be configured to authenticate the request and to check the authorization of the request, for example, through local settings.

The connection module 325 may perform and/or facilitate the performance of the authenticated and/or authorized request, such as searching, reading from and/or writing to the database 330. The request results are transmitted back to the management service 310, which transmits the results back to the requesting client computing device 305a-305n for display on a display component. According to some embodiments, the displayed data is removed from the client computing device 305a-305n responsive to closing of the client management application used to request and/or view the data. In this manner, the database is not stored and/or replicated on any computing devices, such as server computing devices hosting the management service 310 and/or the requesting client computing device 305a-305n, and the entity's data remains secure behind the entity firewall 320.

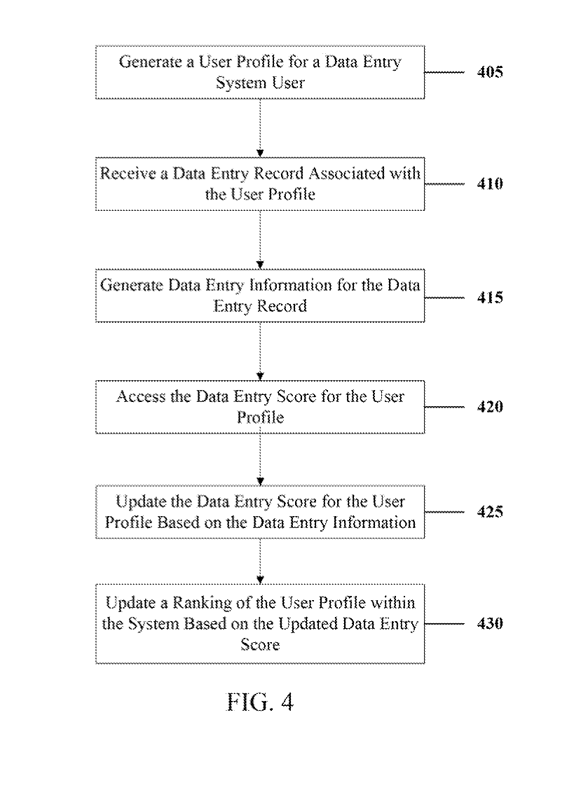

FIG. 4 depicts a flow diagram for an illustrative method for managing and incentivizing data entry using a data management system configured according to some embodiments. According to some embodiments, the steps of the flow diagram depicted in FIG. 4 may be executed by various components of the data management system, such as one or more logic devices. The method may include more or fewer steps and/or may be performed in a sequence different than the sequence depicted in FIG. 4.

A user profile may be generated 405 for a system user of the data management system. The user profile may include various elements assigned to the user, such as a user name and password, authentication information, security/system access information, and a data entry score. The data management system may receive 410 a data entry record associated with the user profile generated 405 on the data management system. For example, the system user may log into the data management system and may enter data entry records from a client computing device that are received 410 by the data management system and, for instance, stored in a database. Data entry information may be generated 415 for the data entry record received 410 by the data management system. The data entry information may include various information elements that are configured to label, describe, define, or otherwise provide data associated with the data entry record.

The data management system may access 420 the data entry score associated with the user profile that entered the data entry record received 410 by the data management system and update 425 the data entry score for the user profile based on the data entry information. The data management system may generate a score for the data entry record based on one or more scoring systems. The score for the data entry record may be applied to the data entry score for the user to generate the updated 425 data entry score. For instance, the data entry score may represent a continuous average of all data entry records associated with the user profile. The data management system may update 430 a ranking of the user profile within the data management system based on the data entry score updated 425 responsive to the data management system receiving 410 the data entry record. For instance, each user profile generated 405 within the data management system may be ranked based on their associated data entry score, such as from highest (best) to lowest (worst).

FIG. 5 depicts a block diagram of exemplary internal hardware that may be used to contain or implement the various computer processes and systems as discussed above. A bus 500 serves as the main information highway interconnecting the other illustrated components of the hardware. CPU 505 is the central processing unit of the system, performing calculations and logic operations required to execute a program. CPU 505, alone or in conjunction with one or more of the other elements disclosed in FIG. 5, is an exemplary processing device, computing device or processor as such terms are used within this disclosure. Read only memory (ROM) 530 and random access memory (RAM) 535 constitute exemplary memory devices.

A controller 520 interfaces with one or more optional memory devices 525 to the system bus 500. These memory devices 525 may include, for example, an external or internal DVD drive, a CD ROM drive, a hard drive, flash memory, a USB drive or the like. As indicated previously, these various drives and controllers are optional devices. Additionally, the memory devices 525 may be configured to include individual files for storing any software modules or instructions, auxiliary data, common files for storing groups of results or auxiliary, or one or more databases for storing the result information, auxiliary data, and related information as discussed above. For example, the memory devices 525 may be configured to store data entry records 120, data entry information 210 or any other information used by the data management system.

Program instructions, software or interactive modules for performing any of the functional steps associated with managing and incentivizing data entry as described above may be stored in the ROM 530 and/or the RAM 535. Optionally, the program instructions may be stored on a tangible computer-readable medium such as a compact disk, a digital disk, flash memory, a memory card, a USB drive, an optical disc storage medium, such as a Blu-ray™ disc, and/or other recording medium.

An optional display interface 530 may permit information from the bus 500 to be displayed on the display 535 in audio, visual, graphic or alphanumeric format. Communication with external devices may occur using various communication ports 540. An exemplary communication port 540 may be attached to a communications network, such as the Internet or a local area network.

The hardware may also include an interface 545 which allows for receipt of data from input devices such as a keyboard 550 or other input device 555 such as a mouse, a joystick, a touch screen, a remote control, a pointing device, a video input device and/or an audio input device.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which alternatives, variations and improvements are also intended to be encompassed by the following claims.

What is claimed is:

1. A system configured to manage and incentivize data entry, the system comprising:
a processor; and
a non-transitory, computer-readable storage medium in operable communication with the processor, wherein the computer-readable storage medium contains one or more programming instructions that, when executed, cause the processor to:
receive a data entry record associated with at least one of a plurality of user profiles,
generate data entry information associated with the data entry record, and
determine at least one data entry score associated with the at least one of a plurality of user profiles based on the data entry information responsive to receiving the data entry element, the data entry score being configured to indicate a correlation between the data entry information and at least one data entry goal.

2. The system of claim 1, wherein the computer-readable storage medium further contains one or more programming instructions that, when executed, cause the processor to rank the plurality of user profiles based on the at least one data entry score.

3. The system of claim 1, wherein the computer-readable storage medium further contains one or more programming instructions that, when executed, cause the processor to partition the plurality of user profiles into a plurality of segments based on the at least one data entry score.

4. The system of claim 1, wherein the computer-readable storage medium further contains one or more programming instructions that, when executed, cause the processor to determine at least one reward based on the at least one data entry score and at least one predetermined score target.

5. The system of claim 1, wherein the computer-readable storage medium further contains one or more programming instructions that, when executed, cause the processor to provide access to the at least one data entry score to at least a portion of the plurality of user profiles.

6. The system of claim 1, wherein the data entry element comprises at least one of the following: a time data entry record, a sales data entry record and a customer support data entry record.

7. The system of claim 1, wherein the at least one data entry goal comprises at least one of the following: timeliness, accuracy and completeness.

8. The system of claim 1, wherein the at least one data entry score comprises at least one of the following: a data entry record score element, a daily data entry score element and a total data entry score element.

9. The system of claim 1, wherein the system is configured as a professional firm time entry system.

10. The system of claim 9, wherein the data entry element comprises a time data entry record and the at least one data entry goal comprises a timeliness of data entry.

11. A computer-implemented method for managing and incentivizing data entry, the method comprising, by a processor:
receiving a data entry record associated with at least one of a plurality of user profiles;
generating data entry information associated with the data entry record; and
determining at least one data entry score associated with the at least one of a plurality of user profiles based on the data entry information responsive to receiving the data entry element, the data entry score being configured to indicate a correlation between the data entry information and at least one data entry goal.

12. The method of claim 11, further comprising ranking the plurality of user profiles based on the at least one data entry score.

13. The method of claim 11, further comprising partitioning the plurality of user profiles into a plurality of segments based on the at least one data entry score.

14. The method of claim 11, further comprising determining at least one reward based on the at least one data entry score and at least one predetermined score target.

15. The method of claim 11, further comprising providing access to the at least one data entry score to at least a portion of the plurality of user profiles.

16. The method of claim 11, wherein the data entry element comprises at least one of the following: a time data entry record, a sales data entry record and a customer support data entry record.

17. The method of claim 11, wherein the at least one data entry goal comprises at least one of the following: timeliness, accuracy and completeness.

18. A computer-readable storage medium having computer-readable program code configured to manage and incentivize data entry embodied therewith, the computer-readable program code comprising:
computer-readable program code configured to receive a data entry record associated with at least one of a plurality of user profiles;
computer-readable program code configured to generate data entry information associated with the data entry record; and
computer-readable program code configured to determine at least one data entry score associated with the at least one of a plurality of user profiles based on the data entry information responsive to receiving the data entry element, the data entry score being configured to indicate a correlation between the data entry information and at least one data entry goal.

19. The computer-readable storage medium of claim 18, further comprising computer readable program code configured to rank the plurality of user profiles based on the at least one data entry score.

20. The computer-readable storage medium of claim 18, further comprising computer readable program code configured to provide access to the at least one data entry score to at least a portion of the plurality of user profiles.
